(19) United States
(12) Patent Application Publication
(10) Pub. No.: US 2026/0158882 A1
(43) Pub. Date: Jun. 11, 2026

(54) REAR DOOR HORIZONTAL STIFFENER

(71) Applicant: FCA US LLC, Auburn Hills, MI (US)

(72) Inventors: Hong Gao, Shanghai (CN); Chunmei Fan, Shanghai (CN); Xiaozhou Jiang, Shanghai (CN); Fanhui Zhang, Shanghai (CN); Hongyu Wang, Shanghai (CN)

(21) Appl. No.: 18/974,927

(22) Filed: Dec. 10, 2024

(51) Int. Cl. B60J 5/04

(52) U.S. Cl. CPC B60J 5/0448; B60J 5/0426; B60J 5/0429

(57) ABSTRACT

A one piece vehicle door stiffener includes a first beam portion and a second beam portion. The second beam portion is angled with respect to the first beam portion at an angle of between 40°to 50°when the first beam portion is on a horizontal line. The first beam portion attaches to a vehicle door at a horizontal side of a window opening. The second beam portion extends towards a non-hinging side of the vehicle door.

### FIELD

The present disclosure relates to automotive vehicle doors and, more particularly, to a rear door stiffener.

### BACKGROUND

This section provides background information related to the present disclosure which is not necessarily prior art.

Automotive doors must meet required collision specifications. Thus, vehicle doors generally include various stiffeners to provide for impact resistance to meet the specifications. Generally, in the rear doors, the door includes a stiffener that has a horizontal part and a vertical part. The two parts are inserted and secured, generally by welding, into the vehicle door during the manufacturing process. Ordinarily, an employee takes the horizontal part and the vertical part during each cycle time to add to the door. This takes the worker time, 12-15 seconds, to load them into a fixture. The worker must utilize both hands in loading the parts into the fixture. Also, the two parts are glued during the process. Accordingly, designers strive to improve the art.

The present disclosure is one to improve the door stiffener over past designs. The present design provides a one piece stiffener that saves on the stamping time as well as the welding time when it is welded to the vehicle. The present disclosures provides improved geometry relative to the position of the horizontal and vertical stiffeners. The present design also provides only one box for the new hinge for a hinge reinforcement. The present design improves the geometry quality while reducing the number of welds as well as being devoid of glue.

### SUMMARY

This section provides a general summary of the disclosure, and is not a comprehensive disclosure of its full scope or all of its features.

According to a first aspect of the disclosure, a one piece vehicle door stiffener comprises a first beam portion and a second beam portion angled with respect to the first beam portion at an angle of between 40° to 50° when the first beam portion is in a horizontal position with respect to the door. The first beam portion attaches to a vehicle door at a horizontal side of a window opening. The second beam portion extends toward a non-hinge side of the vehicle door. The first beam portion is a stamped metal part including apertures and at least one raised rib reinforcement extending along the length of the first beam. The second beam portion has an overall rectangular configuration with two ends. The ends are flat with at least one raised reinforcement between the two ends. The at least one raised reinforcement rib includes a main body portion and an end portion on each side. The end portion have a height less than the main body portion. The reinforcement rib ends includes apertures and enable fasteners to pass therethrough.

According to a second aspect of the disclosure, a vehicle car door comprises an inner skin and an outer skin coupled with one another. A cavity is formed between the inner and outer skin. A stiffener is positioned between the inner and outer skins. The stiffener includes a first beam portion and a second beam portion angled with respect to the first beam portion at an angle of between 40° to 50° when the first beam portion is in a horizontal position with respect to the door. The first beam portion attaches to a vehicle door at a horizontal side of a window opening. The second beam portion extends toward a non-hinge side of the vehicle door. The first beam portion is a stamped metal part including apertures and at least one raised rib reinforcement extending along the length of the first beam. The second beam portion has an overall rectangular configuration with two ends. The ends are flat with at least one raised reinforcement between the two ends. The at least one raised reinforcement rib includes a main body portion and an end portion on each side. The end portion have a height less than the main body portion. The reinforcement rib ends includes apertures and enable fasteners to pass therethrough.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective schematic view of a vehicle door.

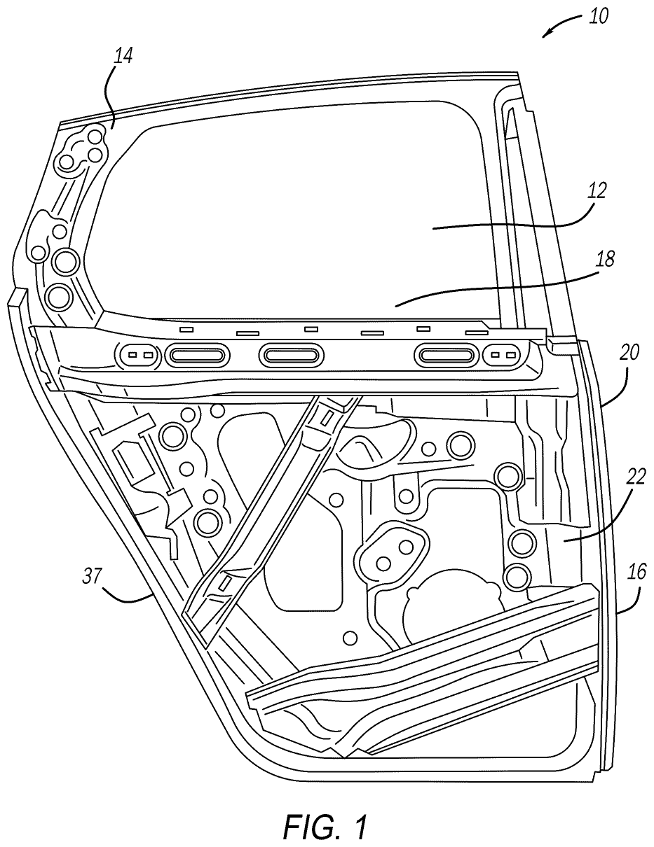

FIG. 2 is a perspective schematic view of the stiffener.

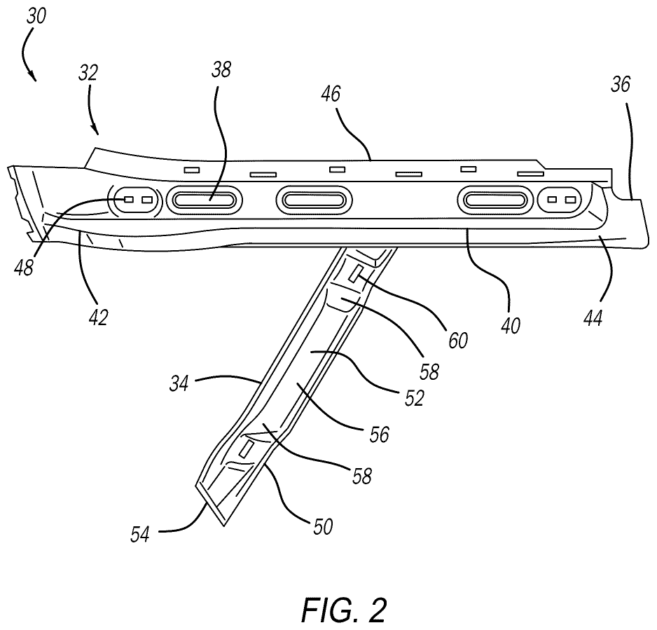

Corresponding reference numerals indicate corresponding parts throughout the several views of the drawings.

### DETAILED DESCRIPTION

Example embodiments will now be described more fully with reference to the accompanying drawings.

Turning to the drawings, a vehicle door is illustrated and designated with the reference numeral 10. The door 10 includes a window opening 12 defined by a U-shape border 14. The door includes a body portion 16 that supports the border 14. The window opening 12 is defined by a horizontal portion 18 at the top of the door body 16 that defines the bottom of the window opening 12. The door 10 includes an outer skin 20 and an inner skin 22.

A stiffener 30 is secured in the inner skin of the door 22. The stiffener 30 includes a horizontal beam 32 and a vertical beam 34. The vertical beam 34 is angled with respect to the horizontal beam 32 at an angle between 40° to 50°. The horizontal beam 32 is positioned at the top of the body 16 along a horizontal line defined by the bottom of the window opening 12. The vertical beam 34 is secured with the inner skin 22 of the door at the non-hinging side 37 of the door body 22. The first beam 32 includes a hinge reinforcement 36 for registering the door with the hinge on the vehicle.

The first beam 32 is a stamped part including a plurality of apertures 38 and at least one raised rib 40. The raised rib 40 is a reinforcement rib and generally extends along the length of the first beam 32. The reinforcement rib 40 generally tapers at its ends 42, 44 to form the reinforcement rib 40. A flange 46 extends from the body 48 of the first beam 32. The flange 46 is generally secured at the top of the door body 16 at the horizontal side of the window opening 12.

The vertical second beam 34 has a body 50 with a reinforcement rib 52 and a pair of ends 54 at the ends of the beam 34. The ends 54 are generally flat with one end secured with the first beam 32 as well as the inner skin of the door 22. The second beam 34 has an overall rectangular configuration with the reinforcement rib 52 between the ends 54. The reinforcement rib 52 includes a main body portion 56 and an end portion 58 on each side of the main body portion 56. The end portions 58 have a height less than the main body portion 56. The reinforcement rib 52 end portions 58 include apertures 60 to enable fasteners to pass therethrough to secure the second beam 34 with the inner skin 22.

The reinforcement stiffener 30 is formed in a one piece construction. The two beams 32, 34 are positioned into a fixture and stamped together to provide the one piece stiffening member 30. The beams 32, 34 are metal and are stamped as one so that a worker can use one hand to put the part into the door frame 10. This saves on stamping equipment costs, working time for the workers and the design meets geometry standards. Also, the present design provides the hinge reinforcement so that one only logistics box is required reducing costs. The stiffener 30 is positioned and secured to the door 10 with minimal welds and also no glue is required to secure it to the door 10.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A one piece vehicle door stiffener comprising:
a first beam portion and a second beam portion angled with respect to the first beam portion and an angle of between 40° to 50° when the first beam portion is horizontal, the first beam portion attaching to a vehicle door at a horizontal side of a window opening, the second beam portion extending towards a non-hinging side of the vehicle door.

2. The one piece vehicle door stiffener of claim 1, wherein the first beam portion is a stamped metal part including apertures and at least one raised rib reinforcement extend along the length of the first beam portion.

3. The one piece vehicle door stiffener of claim 1, wherein the second beam portion has an overall rectangular configuration with two ends.

4. The one piece vehicle door stiffener of claim 3, wherein the ends are flat with at least one raised reinforcement rib between the two ends.

5. The one piece vehicle door stiffener of claim 4, wherein the at least one raised reinforcement rib includes a main body portion and an end portion on each side, the end portions having a height less than the main body portion.

6. The one piece vehicle door stiffener of claim 5, wherein the reinforcement rib ends include apertures enabling fastener passage.

7. A vehicle car door comprising:
an inner skin and an outer skin coupled with one another, a cavity between said skins;
a stiffener between the inner and outer skins, the stiffener including:
a first beam portion and a second beam portion angled with respect to the first beam portion and an angle of between 40° to 50° when the first beam portion is horizontal, the first beam portion attaching to a vehicle door at a horizontal side of a window opening, the second beam portion extending towards a non-hinging side of the vehicle door.

8. The vehicle car door of claim 7, wherein the first beam portion is a stamped metal part including apertures and at least one raised rib reinforcement extend along the length of the first beam portion.

9. The vehicle car door of claim 7, wherein the second beam portion has an overall rectangular configuration with two ends.

10. The vehicle car door of claim 9, wherein the ends are flat with at least one raised reinforcement rib between the two ends.

11. The vehicle car door of claim 10, wherein the at least one raised reinforcement rib includes a main body portion and an end portion on each side, the end portions having a height less than the main body portion.

12. The vehicle car door of claim 11, wherein the reinforcement rib ends include apertures enabling fastener passage.
